(19) United States
(12) Patent Application Publication
(10) Pub. No.: US 2013/0314605 A1
(43) Pub. Date: Nov. 28, 2013

(54) CONTENT TRANSMITTER AND CONTENT TRANSMISSION METHOD

(71) Applicant: Takashi Minemura, Ome-shi (JP)

(72) Inventor: Takashi Minemura, Ome-shi (JP)

(21) Appl. No.: 13/718,263

(22) Filed: Dec. 18, 2012

(30) Foreign Application Priority Data
May 23, 2012 (JP) 2012-117938

(51) Int. Cl. H04N 5/38

(52) U.S. Cl. CPC H04N 5/38
USPC 348/723

(57) ABSTRACT

According to one embodiment, content transmitter includes: communication module; content protector; determination module; and controller. The content protector transmits content using a first protection method on transmission path between the content receiver and the content transmitter. The determination module determines whether communication distance of the transmission path is within predetermined range. The controller causes the content protector to start transmitting the content using the first protection method if it is determined that the communication distance is within the range. The controller causes the determination module to intermittently determine whether the communication distance is within the range during the transmission. The controller causes the content protector to continue the transmission if it is determined that the communication distance is within the range during the transmission. The controller causes the content protector to stop the transmission if it is determined that the communication distance is outside the range during the transmission.

### CROSS-REFERENCE TO RELATED APPLICATIONS

This application is based upon and claims the benefit of priority from Japanese Patent Application No. 2012-117938, filed May 23, 2012, the entire contents of which are incorporated herein by reference.

### FIELD

Embodiments described herein relate generally to a content transmitter and a content transmission method.

### BACKGROUND

Conventionally, among electronics such as a television receiver, a recorder, a tablet terminal, and the like, when a content is transmitted while protecting the copyright thereof from a source device that is one of the electronics (hereinafter, referred to as a content transmitter) transmitting a file of the content (hereinafter, referred to as a content) to a sink device that is one of the electronics receiving the content transmitted (hereinafter, referred to as a content receiver), transmission of the content using a copyright protection method such as a digital transmission content protection over internet protocol (DTCP-IP) is performed.

According to DTCP-IP, a round trip time (RTT) measurement is performed once as a pre-verification, and if the RTT value is not larger than a threshold (e.g., 7 ms), transmission of the content, which is a target of the copyright protection, is performed. However, according to the conventional art described above, the pre-verification is performed through the RTT measurement only before the transmission of the content. Therefore, in case when a wireless transmission path which is different from a wired transmission path with which stable transmission quality can be expected is used, a change over time in the transmission quality due to the movement of the content receiver cannot be addressed.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of a schematic configuration of a system comprising a content transmitter and a content receiver according to a first embodiment;

FIG. 2 is an exemplary block diagram of a functional configuration of the content transmitter in the first embodiment;

FIG. 3 is an exemplary block diagram of a functional configuration of the content receiver in the first embodiment;

FIG. 4 is an exemplary flowchart of operations of the content transmitter in the first embodiment;

FIG. 5 is an exemplary flowchart of wireless path quality verification processing or RTT verification processing in the first embodiment;

FIG. 6 is an exemplary graph of frequency distribution of measurement results of the RTT in the first embodiment;

FIG. 7 is an exemplary flowchart of corrected threshold value calculation processing in the first embodiment;

FIG. 8 is an exemplary flowchart of operations of a content transmitter according to a first modification in the first embodiment;

FIG. 9 is an exemplary flowchart of operations of a content transmitter according to a second modification in the first embodiment;

FIG. 10 is an exemplary block diagram of a functional configuration of a content transmitter according to a second embodiment; and

FIG. 11 is an exemplary block diagram of a functional configuration of a content receiver in the second embodiment.

### DETAILED DESCRIPTION

In general, according to one embodiment, a content transmitter comprises: a communication module; a content protector; a determination module; and a controller. The communication module is configured to communicate with a content receiver. The content protector is configured to transmit a content using a first protection method on a transmission path between the content receiver and the content transmitter. The determination module is configured to determine whether a communication distance of the transmission path is within a predetermined range based on a communication with the content receiver. The controller is configured to cause the content protector to start transmitting the content using the first protection method if it is determined that the communication distance is within the predetermined range. The controller is configured to cause the determination module to intermittently determine whether the communication distance is within the predetermined range during the transmission of the content. The controller is configured to cause the content protector to continue the transmission of the content using the first protection method if it is determined that the communication distance is within the predetermined range during the transmission of the content. The controller is configured to cause the content protector to stop the transmission of the content using the first protection method if it is determined that the communication distance is outside the predetermined range during the transmission of the content.

With reference to the accompanying drawings, embodiments of a content transmitter and a content transmission method will now be described in detail.

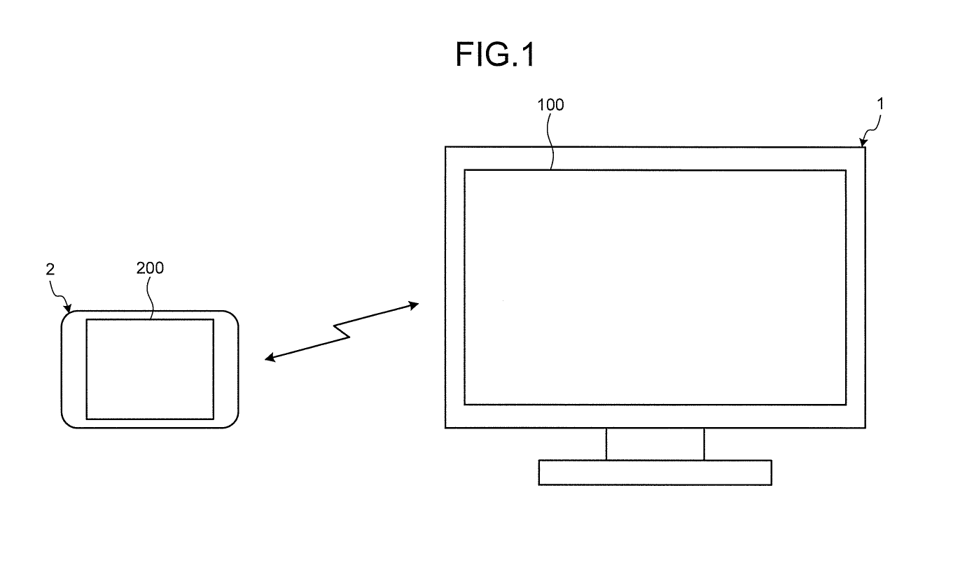

FIG. 1 is a view for explaining a schematic configuration of an example of a system comprising a content transmitter 1 and a content receiver 2 according to a first embodiment. As illustrated in FIG. 1, the content transmitter 1 is a television receiving apparatus comprising a display 100 such as a liquid crystal display. The content receiver 2 is a tablet terminal comprising a display 200 such as a liquid crystal display on which a touch panel is laminated.

The content transmitter 1 and the content receiver 2 are communicatively coupled to each other through a wired or wireless transmission path, such as High-Definition Multimedia Interface (HDMI (registered trademark)), WirelessHD, or a wireless LAN (IEEE 802.11 series etc.) in the 5 GHz band or the 2.5 GHz band. In the first embodiment, an example in which the content transmitter 1 and the content receiver 2 are coupled to each other through a wireless connection and the content receiver 2 is mobile is described. However, on the way from the content transmitter 1 to the content receiver 2, a wired connection may be comprised. For example, in an example in which a repeater for a wireless LAN access point (not illustrated) is used, the connection from the content transmitter 1 to the repeater may be wired, while from the repeater to the content receiver 2 may be connected through the wireless LAN. The repeater described above may be provided in plural in each room or on each floor within a house. In an example in which the repeater is provided in each room or on each floor, by switching the repeater that communicates with the content receiver 2 to another repeater, while being carried across the rooms or floors in the house, the content receiver 2 can continue to communicate with the content transmitter 1 stably.

The content transmitter 1 transmits a video signal (image data) or its accompanying audio signal (audio data) of a content such as a program received in digital terrestrial broadcasting to the content receiver 2 through the transmission path described above. The content receiver 2 can receive the video signal and the audio signal transmitted from the content transmitter 1 to output an image and an audio relating to the video signal and the audio signal.

The content transmitter 1 and the content receiver 2 comply with a technology referred to as digital living network alliance (DLNA) that achieves interoperation of digital home network devices and support content protection methods such as DTCP-IP, high-bandwidth digital content protection (HDCP), serial copy management system (SCMS), and the like. That is to say, the content transmitter 1 is equivalent to a source device in DLNA, while the content receiver 2 is equivalent to a sink device in DLNA. The content transmitter 1 can transmit a content such as a program received in digital terrestrial broadcasting while protecting a copyright thereof to the content receiver 2. As a content transmission method other than described above, a method adopting a wireless image rendering technology such as a Wi-Fi Display may be used.

In the first embodiment, a general television receiver is exemplified as the content transmitter 1, while a general tablet terminal is exemplified as the content receiver 2. However, it is to be understood that the content transmitter 1 and the content receiver 2 may be a device such as a hard disk recorder or a set top box, as long as it transmits or receives a content such as a program received in the digital terrestrial broadcasting.

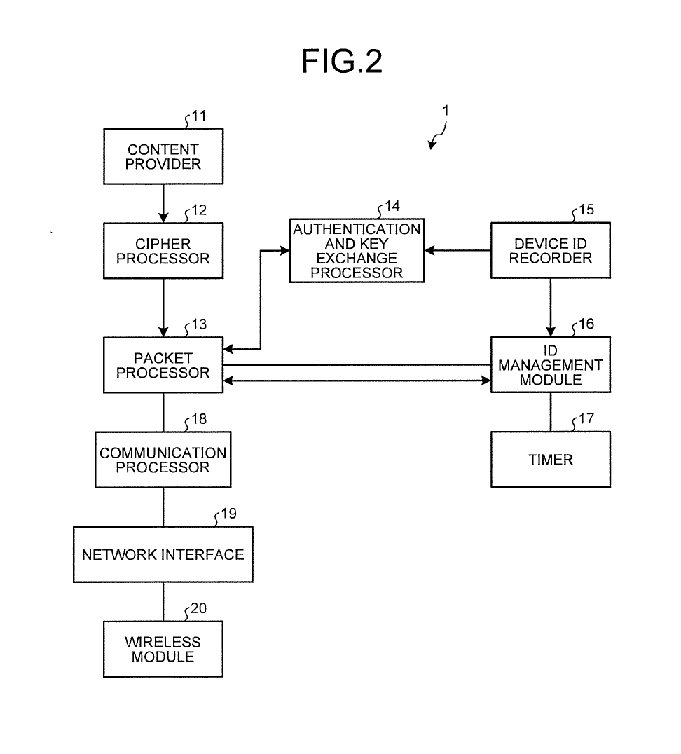

FIG. 2 is a block diagram of an example of a functional configuration of the content transmitter 1 in the first embodiment. As illustrated in FIG. 2, in the content transmitter 1, a central processing unit (CPU) loads computer programs stored in a storage module such as a read only memory (ROM) or a hard disk drive (HDD) to a random access memory (RAM) (none of them illustrated) and sequentially executes the programs, whereby the content transmitter 1 achieves functions as a content provider 11, a cipher processor 12, a packet processor 13, an authentication and key exchange processor 14, a device ID recorder 15, an ID management module 16, a timer 17, and a communication processor 18. A network interface 19 is an interface that accepts the connection to HDMI (registered trademark) (not illustrated) or a wireless module 20. The wireless module 20 performs wireless communication in accordance with a predetermined transmission method such as WirelessHD and the wireless LAN. The content transmitter 1 communicates, under control of the communication processor 18, communicates with the content receiver 2 through HDMI (registered trademark) or the wireless module 20 coupled to the network interface 19.

The content provider 11 provides the content to be transmitted to the content receiver 2 to the cipher processor 12. An example of the content to be transmitted to the content receiver 2 is a content received by a tuner (not illustrated) for the digital terrestrial broadcasting or BS digital broadcasting, and is a content in which transmission thereof has been directed by the user's operation through a remote control (not illustrated) of the content transmitter 1 or a touch panel of the content receiver 2. For example, the content that has been directed to be transmitted or received through a program listing such as an electronic program guide (EPG) is received by the tuner and provided to the cipher processor 12 as the content to be transmitted to the content receiver 2.

The cipher processor 12 performs encryption processing on the content and decryption processing on the content encrypted. Specifically, the cipher processor 12 performs encryption and decryption processing complied with DTCP-IP or HDCP. When the content is transmitted using a first content protection method (described in detail later), the cipher processor 12 encrypts the content provided from the content provider 11 to be transmitted to the packet processor 13.

The packet processor 13 performs packet processing complied with a predetermined protection method on the content that is transmitted to and received from the content receiver 2 under the control of the communication processor 18. The protection method herein is a technological method relating to transmitting and receiving the content on the purpose of copyright protection of the content, namely, the first content protection method and a second content protection method. The first content protection method determines that a physical or electrical communication distance between the content transmitter 1 and the content receiver 2 is within a predetermined range (e.g., in a home), and performs encryption upon transmission. An example of the first content protection method is DTCP-IP and HDCP. The second content protection method requires no determination that a physical or electrical communication distance between the content transmitter 1 and the content receiver 2 is within a predetermined range. An example of the second content protection method is SCMS.

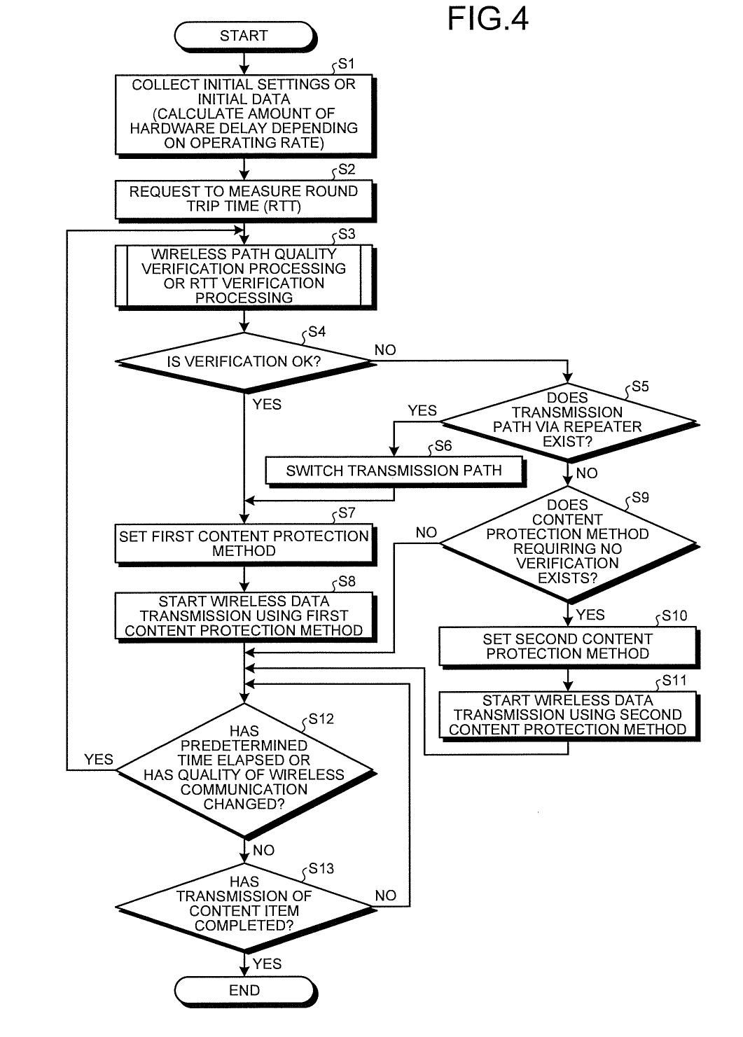

If the first content protection method is used, the packet processor 13 performs authentication and key exchange between the content transmitter 1 and the content receiver 2 in the authentication and key exchange processor 14. During the authentication and key exchange, the packet processor 13 performs wireless path quality verification processing or round trip time (RTT) verification processing (refer to S3 illustrated in FIG. 4) to check whether the communication distance of the transmission path between the content transmitter 1 and the content receiver 2 is within a predetermined range based on the communication with the content receiver 2 (described in detail later). If it is determined that the communication distance is within the predetermined range, the packet processor 13 stores, under the control of the communication processor 18, the content encrypted in the cipher processor 12 into an IP packet to be output to the communication processor 18.

The device ID of the content receiver 2 and the device ID of the content transmitter 1 recorded in the device ID recorder 15, between which authentication and key exchange has been performed, are managed in the ID management module 16. The packet processor 13 monitors an unauthorized transmitting and receiving the content with reference to information managed in the ID management module 16. The timer 17 is a functional module that measures a time. For example, the timer 17 measures a time when an RTT is verified.

If the second content protection method is used, the packet processor 13 adds management information for managing copying of the content to the content provided from the content provider 11 to be stored into an IP packet to be output to the communication processor 18. The management information relating to the copying may be, for example, two-digit information referred to as copy bits. The packet processor 13 adds the copy bits directing never to copy on the content to be output to the communication processor 18.

In addition, if the second content protection method is used, the content may be transmitted with a transmission rate lowered than that of the first content protection method described above. Specifically, if the second content protection method is used, the packet processor 13 samples the content in lowered quality, thumbnails the content, or creates a still image from a moving image to be output to the communication processor 18.

The communication processor 18 controls operations while transmitting the content to and receiving the content from the content receiver 2. Specifically, if it is determined that the communication distance to the content receiver 2 is within a predetermined range, the communication processor 18 causes the packet processor 13 to start transmitting the content using the first content protection method. Then, the communication processor 18 causes the packet processor 13 to intermittently determine that the communication distance to the content receiver 2 is within the predetermined range during the transmission of the content. If it is determined that the communication distance is within the predetermined range during the transmission of the content, the communication processor 18 causes the packet processor 13 to continue the transmission of the content using the first content protection method. If it is determined that the communication distance is outside the predetermined range during the transmission of the content, the communication processor 18 causes the packet processor 13 to stop the transmission of the content using the first content protection method. Therefore, in the content transmitter 1, the content can be transmitted using a protection method (copyright protection method) that addresses a change over time in the transmission quality occurring due to the movement of the content receiver 2 or the like.

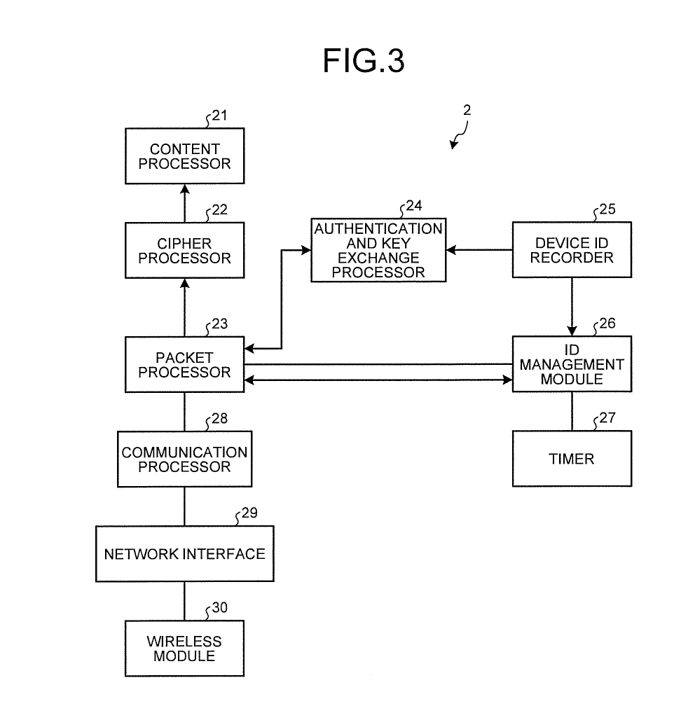

FIG. 3 is a block diagram of an example of a functional configuration of the content receiver 2 in the first embodiment. As illustrated in FIG. 3, in the content receiver 2, a CPU loads computer programs stored in a storage module such as a ROM or an HDD to a RAM and sequentially executes the programs (none of them illustrated), whereby the content receiver 2 achieves functions as a content processor 21, a cipher processor 22, a packet processor 23, an authentication and key exchange processor 24, a device ID recorder 25, an ID management module 26, a timer 27, and a communication processor 28. A network interface 29 is an interface that accepts the connection to HDMI (registered trademark) or a wireless module 30. The wireless module 30 performs wireless communication in accordance with a predetermined transmission method such as WirelessHD and the wireless LAN. The content receiver 2 communicates, under the control of the communication processor 28, with the content transmitter 1 through HDMI (registered trademark) coupled to the network interface 29 or the wireless module 30.

The cipher processor 22, the packet processor 23, the authentication and key exchange processor 24, the device ID recorder 25, the ID management module 26, the timer 27, and the communication processor 28 are the same as the cipher processor 12, the packet processor 13, the authentication and key exchange processor 14, the device ID recorder 15, the ID management module 16, the timer 17, and the communication processor 18 in the content transmitter 1. The difference is processing to output the content received to the content processor 21 (if the first content protection method is used, decryption processing is performed in the cipher processor 22 to be output to the content processor 21). The content processor 21 performs content processing such as displaying the content received through the wireless module 30 to the display 200 and storing the content in a storage module (e.g., HDD). The content processing of the content processor 21 is subject to management information relating to copying that has been added to the content received.

The operations of the content transmitter 1 relating to the transmission of the content will now be described in detail. FIG. 4 is a flowchart of an example of operations of the content transmitter 1 in the first embodiment.

As illustrated in FIG. 4, after the transmission of the content has been instructed through the user's operation and processing relating to the transmission of the content is started, the communication processor 18 performs collection of initial settings or initial data (S1). The initial settings or initial data collected at S1 is an amount of hardware delay due to the operating rate, required for the determination that the communication distance to the content receiver 2 is within a predetermined range. At S1, a delay time due to the hardware is calculated based on an operation state inside the apparatus (e.g., the operating rate of the CPU or a graphics processing unit (GPU)) to collect the initial settings or initial data.

Subsequently, the communication processor 18 requests the packet processor 13 to measure the round trip time (RTT) (S2). The request to measure RTT is a measurement request for in-home or out-of-home verification performed prior to the transmission of the content, and specifically, a measurement request for verification of whether the RTT values in message transmission and reception up to 1024 times are equal to or smaller than 7 ms. Subsequently, the packet processor 13 performs the wireless path quality verification processing or the RTT verification processing (S3).

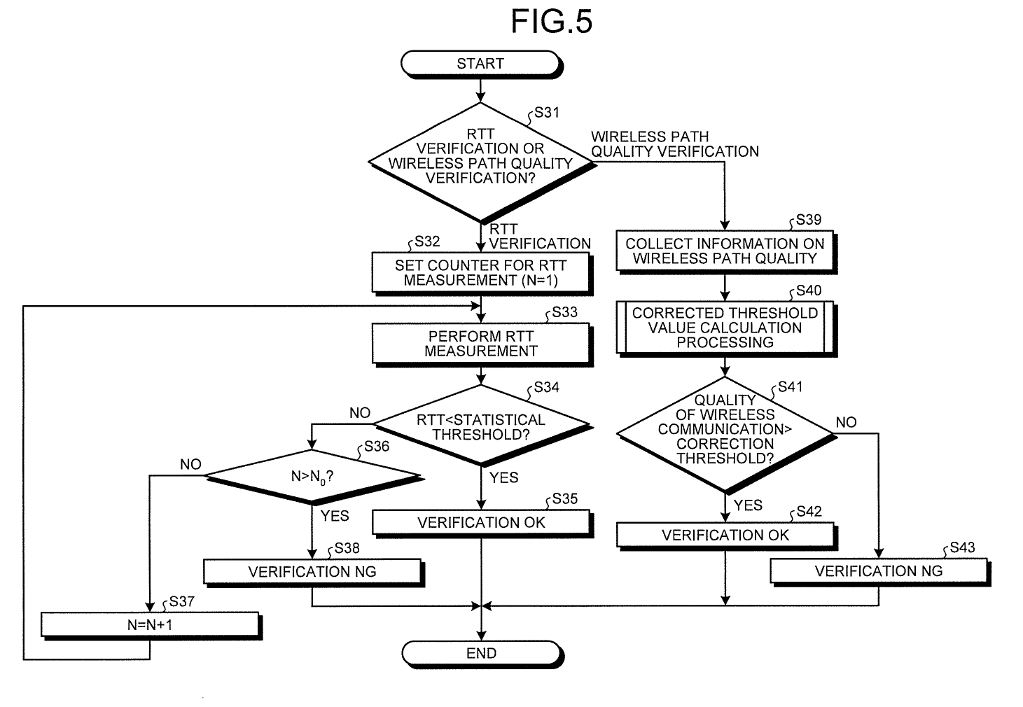

FIG. 5 is a flowchart of an example of the wireless path quality verification processing or the RTT verification processing. As illustrated in FIG. 5, after the wireless path quality verification processing or the RTT verification processing is started, the packet processor 13 determines which of the RTT verification and the wireless path quality verification to be performed (S31). For example, if the request to measure the RTT is issued at S2, the packet processor 13 determines to perform the RTT verification. After the wireless path quality verification processing or the RTT verification processing is started during the transmission of the content (S8→Yes at S12, illustrated in FIG. 4) either the RTT verification or the wireless path quality verification may be determined to be performed. For example, the one that has been set in a ROM or the like is determined to be performed.

If the RTT verification is determined to be performed at S31, the packet processor 13 makes settings on a counter for an RTT measurement (N=1) (S32). The counter indicates the number of trials of transmitting and receiving the message to measure the RTT value, to which N=1 is set as an initial value. Subsequently, the packet processor 13 performs the RTT measurement (S33).

Specifically, the packet processor 13 creates and then encrypts a message to be transmitted to the content receiver 2. The packet processor 13 receives the message from the content receiver 2. Then, the packet processor 13 collates the message transmitted to the content receiver 2 with the message received from the content receiver 2. The packet processor 13 measures this time period as an RTT value. If the RTT value is smaller than a predetermined threshold (e.g., 7 ms), it is determined that the physical or electrical communication distance between the content transmitter 1 and the content receiver 2 is within the predetermined range (e.g., in-home).

After the wireless path quality verification processing or the RTT verification processing is started during the transmission of the content (S8→Yes at S12, illustrated in FIG. 4), and if the RTT measurement is performed, the packet processor 13 encourages to establish another communication session different from the communication session through which the content is being transmitted. Then, the packet processor 13 uses the newly established communication session to perform the RTT measurement. As described above, by establishing a new communication session for the RTT measurement during the transmission of the content, interruption of the transmission of the content due to performing authentication and key exchange (AKE) subsequent to the RTT measurement upon request of HDCP can be avoided.

In the first embodiment, the packet processor 13 also determines whether the RTT value obtained by measuring the RTT a plurality of times is smaller than a statistical threshold (S34). Specifically, the packet processor 13 records the RTT values obtained by measuring the RTT a plurality of times using the counter N sequentially in a working area in the RAM. The packet processor 13 determines whether the communication time period with the content receiver 2 based on the frequency of the several RTT values is smaller than a reference time period that has been set in advance.

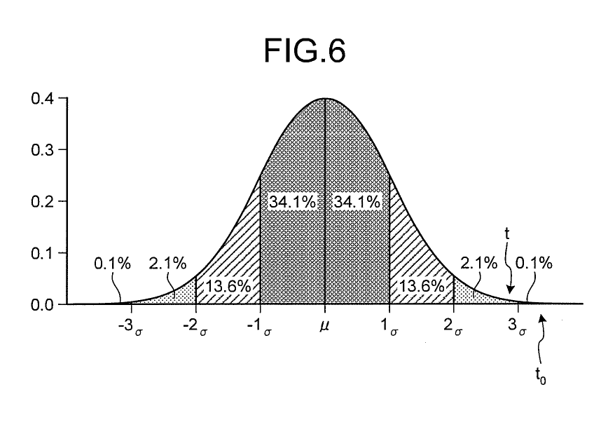

FIG. 6 is a graph of an example of frequency distribution of measurement results of RTT. As illustrated in FIG. 6, the frequency distribution of the RTT values is obtained by measuring the RTT values a plurality of times using the counter N. Then, based on the frequency distribution obtained, the statistical threshold time is calculated. Specifically, the frequency distribution of the RTT values measured +3σ shall be a statistical threshold time t. If the statistical threshold time t is smaller than the reference time t0, it is determined that the communication distance to the content receiver 2 is within a predetermined range and the wireless communication environment is stable. As described above, by determining not only that the RTT value measured is smaller than the predetermined threshold once, but also that the statistical threshold time t is smaller than the reference time t0, it can be determined that the wireless communication environment is stable, whereby a block noise or reduction of the audio quality occurring on the side of the content receiver 2 can be avoid.

If the RTT value is smaller than the statistical threshold (Yes at S34), the verification (determination) of the RTT measurement is determined to be OK and the processing ends (S35). If the RTT value is not smaller than the statistical threshold (No at S34), the packet processor 13 determines whether the counter N is larger than the number of times N₀ that is the maximum of the number of trial (S36). If the counter N is not larger than the number of times N₀ (No at S36), the packet processor 13 increments the counter N and returns the processing to S33. If the counter N is larger than the number of times N₀ (Yes at S36), verification (determination) of the RTT measurement is determined to be NG and the processing ends (S38).

If the wireless path quality verification is determined to be performed at S31, the packet processor 13 collects information on the wireless path quality (S39), and performs corrected threshold value calculation processing (S40). The information on the wireless path quality is quality information representing the quality of the (wireless) communication with the content receiver 2. An example of the quality information is, a carrier to noise ratio (CNR) or a carrier to interference and noise ratio (CINR). At S39, the measurements of CNR or CINR, for example, measured by the wireless module 20 intermittently for link adaptation are collected.

The corrected threshold value calculation processing at S40 can be performed if the corrected threshold value data has not been recorded in advance. On the other hand, if the corrected threshold value data has been recorded in advance in the ROM or the like, this processing may be skipped. As one example of the method, the content transmitter 1 and the content receiver 2 are coupled to each other through a coaxial cable, a variable attenuator is provided in the middle of the coaxial cable to obtain a packet error rate, and the corrected threshold value data based on the packet error rate is recorded in the ROM in advance. By also performing the RTT measurement at the same time, a direct conversion table between the wireless path quality and the RTT value can be created.

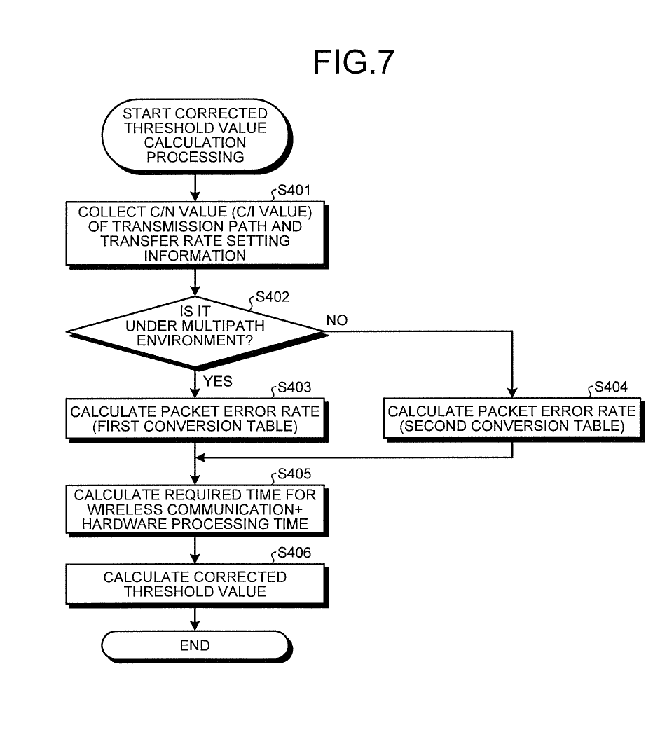

FIG. 7 is a flowchart of an example of the corrected threshold value calculation processing. As illustrated in FIG. 7, after the corrected threshold value calculation processing is started, the packet processor 13 collects the CNR value (represented with a real number as a C/N value) or the CINR (represented with a real number as a C/I value) value of the transmission path to the content receiver 2, and the bit rate of the content to be transmitted, that is, the transmission rate of the content (transfer rate setting information) to be transmitted (S401).

Subsequently, the packet processor 13 determines whether the communication with the content receiver 2 through the wireless module 20 is under a multipath environment (S402). The determination of whether the communication is under a multipath environment is performed because the conversion table used for calculating the packet error rate that is an error rate when transmitting the content differs depending on whether the communication is under a multipath environment. The information on whether the communication is under a multipath environment is already known before the communication with the content receiver 2 is started in the wireless module 20.

Then, if the communication is under a multipath environment (Yes at S402), the packet processor 13 calculates the packet error rate based on the CNR value or the CINR value collected at S401 and the transmission rate of the content to be transmitted with reference to a first conversion table. If the communication is not under a multipath environment (No at S402), the packet processor 13 calculates the packet error rate based on the CNR value or the CINR value and the transmission rate of the content to be transmitted with reference to a second conversion table.

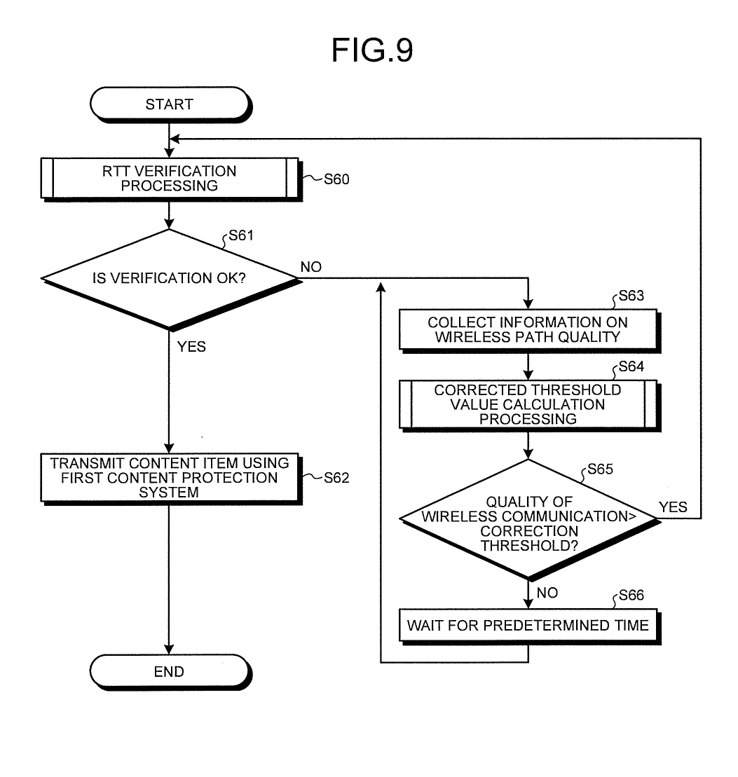

The first conversion table and the second conversion table are table information in which the relationships between the CNR value or the CINR value and an error rate in transmission for each transmission rate are described. The conversion table has different conditions depending on whether the communication is under a multipath environment, therefore, two different tables are provided in advance to be recorded in the ROM or the like. Specifically, the second conversion table equivalent to the graph representing the relationships between the C/N value and the packet error rate (PER) for each transmission rate (transfer speed) as illustrated in FIGS. 9 to 21 in “802.11 High-speed Wireless LAN Textbook, Morikura and Kubota, the third revised edition, the standard textbook series, Impress” is recorded in the ROM or the like in advance. If an AWGN channel, which is described in the literature above, is used, the first conversion table equivalent to the graph representing the relationships between the C/N value and the PER value in a multi-channel, is recorded in the ROM or the like in advance.

Subsequently, the packet processor 13 calculates a required time (transmission time) for the wireless communication between the content transmitter 1 and the content receiver 2+hardware processing time using the packet error rate calculated at S403 or S404 (S405). Then, based on the calculation result at S405, the packet processor 13 calculates the corrected threshold value (the C/N value or the C/I value) that is a threshold of information on the wireless path quality when the communication distance between the content transmitter 1 and the content receiver 2 is within the predetermined range (S406).

With reference to FIG. 5 again, after S40, the packet processor 13 determines whether the value of the wireless path quality (the C/N value or the C/I value of the transmission path to the content receiver 2) collected at S39 is larger than the corrected threshold value (S41). If the value of the wireless path quality is larger than the corrected threshold value (Yes at S41), the communication distance to the content receiver 2 estimated from the wireless path quality is within the predetermined range. As a result, the packet processor 13 determines the verification (determination) to be OK and ends the processing (S42). If the value of the wireless path quality is not larger the corrected threshold value (No at S41), the communication distance to the content receiver 2 is estimated from the wireless path quality to be outside the predetermined range. As a result, the packet processor 13 determines the verification (determination) to be NG (S43) and ends the processing.

With reference to FIG. 4 again, after the wireless path quality verification processing or the RTT verification processing (S3), the communication processor 18 determines whether the result of the wireless path quality verification processing or the RTT verification processing is verified to be OK (S4). If the result of the wireless path quality verification processing or the RTT verification processing is not OK (No at S4), the communication processor 18 determines whether a transmission path via a repeater exists (S5) If the wireless path quality verification processing or the RTT verification processing is performed during the transmission of the content (S8→Yes at S12→S3) and the result of the wireless path quality verification processing or the RTT verification processing during the transmitting of the content using the first content protection method is not OK (No at S4), the communication processor 18 stops the transmission of the content using the first content protection method.

If the repeater that relays the communication with the content receiver 2 is provided in each room or on each floor, it is possible to switch a transmission path from the transmission path directly and wirelessly communicating with the content receiver 2 to a transmission path via a plurality of repeaters. Therefore, if the network interface 29 is coupled to the repeater, through which a communication with the content receiver 2 is possible (Yes at S5), the communication processor 18 encourages to switch to the transmission path on the side of the repeater (S6). Specifically, if the network interface 29 is coupled to the repeater, the IP address or the MAC address has been obtained in advance to set the path to the repeater side. Accordingly, whether the communication with the content receiver 2 is possible is determined using a communication through an address of the repeater side. If the repeater has a wireless connection, the transmission path is formed through the wireless module 20. Then, when the connection of the transmission path with the content receiver 2 is possible, the communication processor 18 switches to the transmission path on the repeater side.

If the result of the wireless path quality verification processing or the RTT verification processing is verified to be OK (Yes at S4), or the communication with the content receiver 2 is possible by switching the transmission path (S6), the communication processor 18 sets the first content protection method in the packet processor 13 (S7). Subsequently, the communication processor 18 starts wireless data transmission using the first content protection method (S8). At S7 and S8, if the wireless path quality verification processing or the RTT verification processing is performed during the transmission of the content (S8→Yes at S12→S3) and the content is already being transmitted using the first content protection method, the transmission of the content using the first content protection method is continued.

If the result of the wireless path quality verification processing or the RTT verification processing is verified to be NG (No at S4) and the communication with the content receiver 2 is impossible by switching the transmission path (No at S5), the communication processor 18 determines whether the transmission using a content protection method requiring no verification, i.e., requiring no determination of whether the communication distance to the content receiver 2 is within the predetermined range (S9). Existence of the transmission using the content protection method requiring no verification may be determined with reference to the setting information that has been made by the user in advance, or may be determined depending on whether the content to be transmitted complies with the content protection method without verification. Specifically, for the content for which no protection method other than the first content protection method is permitted due to the copyright information or the like added to the content, the transmission using the content protection method requiring no verification is determined not to exist. For the content without the limitation described above, the transmission using the content protection method requiring no verification is determined to exist.

If the transmission using the content protection method requiring no verification is determined to exist (Yes at S9), the communication processor 18 sets the second content protection method in the packet processor 13 (S10). Subsequently, the communication processor 18 causes the packet processor 13 to start wireless data transmission using the second content protection method (S11). Therefore, even if it cannot be determined that the communication distance to the content receiver 2 is within the predetermined range, the content can be transmitted using the second content protection method.

After S8, No at S9, and S11, the communication processor 18 determines whether a predetermined time has elapsed using the timer 17 or whether the quality of the wireless communication with respect to the content receiver 2 has changed based on the CNR value or the CINR value measured by the wireless module 20 intermittently for link adaptation (S12). If the predetermined time has elapsed or the quality of the wireless communication has changed (Yes at S12), the communication processor 18 returns the processing to S3. Accordingly, in accordance with the fact that the predetermined time has elapsed and the quality of the wireless communication with respect to the content receiver 2 has changed, in the content transmitter 1, it becomes possible to intermittently determine whether the communication distance with respect to the content receiver 2 is within a predetermined range.

If the predetermined time has not elapsed or the quality of the wireless communication has not been changed (No at S12), the communication processor 18, determines whether the transmission of the content to the content receiver 2 has completed (S13). If the transmission of the content has not completed (No at S13), the communication processor 18 returns the processing to S12 to continue the transmission of the content. If the transmission of the content has completed (Yes at S13), the communication processor 18 ends the processing.

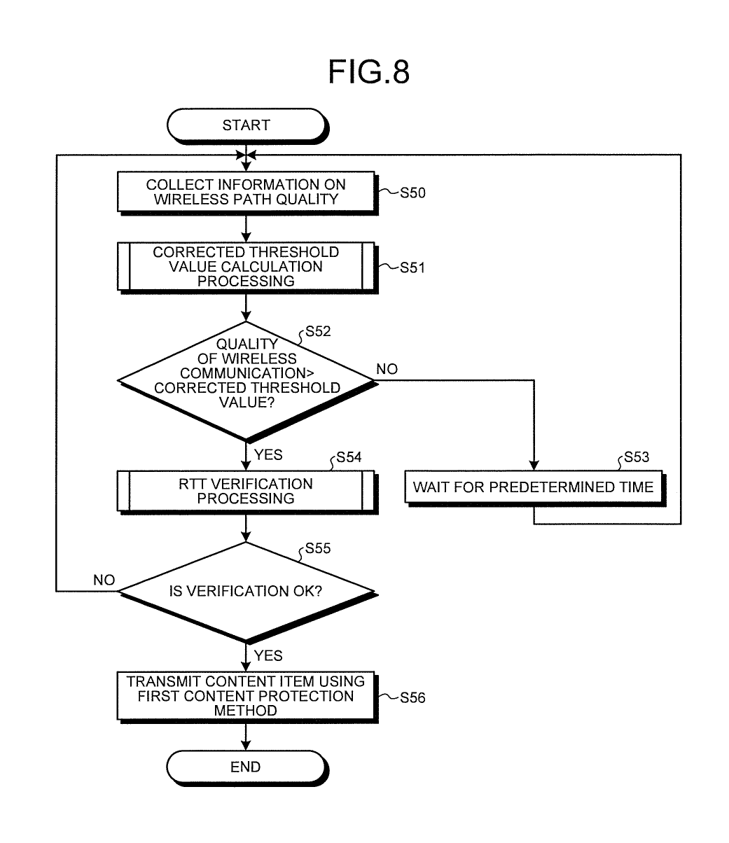

A first modification of the first embodiment described above will now be explained. FIG. 8 is a flowchart of an example of operations of the content transmitter 1 in the first modification of the first embodiment. In the first modification illustrated in FIG. 8, in the wireless path quality verification processing or the RTT verification processing, the flow of processing to check whether the communication distance to the content receiver 2 is within a predetermined range differs from the first embodiment described above.

As illustrated in FIG. 8, after the processing is started, in the same manner as S39 and S40, the packet processor 13 collects the information on the wireless path quality (S50), and performs the corrected threshold value calculation processing (S51). Subsequently, in the same manner as S41, the packet processor 13 determines whether the value of the wireless path quality is larger than the corrected threshold value (S52). If the wireless path quality is not larger than the corrected threshold value (No at S52), the packet processor 13 waits for a predetermined time (S53) and returns the processing to S50.

If the value of the wireless path quality is larger than the corrected threshold value (Yes at S52), the packet processor 13 performs the RTT verification processing equivalent to S32 to S37 (S54). Subsequently, the packet processor 13 determines whether the result of the RTT verification processing is OK (S55). Then, if the result is OK (Yes at S55), the communication processor 18 causes the packet processor 13 to start the transmission of the content using the first content protection method (S56). If the result is not OK (No at S55), the communication processor 18 returns the processing to S50.

As described above, in the first modification 1, if the value of the wireless path quality to the content receiver 2 is larger than the corrected threshold value and if the communication distance to the content receiver 2 is determined to be within the predetermined range based on the communication quality, the RTT is measured with respect to the content receiver 2, thereby measuring the RTT in a state in which the communication state is stable.

A second modification of the first embodiment described above will now be explained. FIG. 9 is a flowchart of an example of operations of the content transmitter 1 in the second modification of the first embodiment. In the second modification illustrated in FIG. 9, in the same manner as the first modification, in the wireless path quality verification processing or the RTT verification processing, the flow of processing to check whether the communication distance to the content receiver 2 is within a predetermined range differs from the first embodiment described above.

As illustrated in FIG. 9, after the processing is started, the packet processor 13 performs the RTT verification processing equivalent to S32 to S37 (S60). Subsequently, the packet processor 13 determines whether the result of the RTT verification processing is OK (S61). Then, if the result is OK (Yes at S61), the communication processor 18 starts the transmission of the content using the first content protection method (S62).

If the result is not OK (No at S61), in the same manner as S39 and S40, the packet processor 13 collects the information on the wireless path quality (S63), and performs the corrected threshold value calculation processing (S64). Subsequently, in the same manner as S41, the packet processor 13 determines whether the value of the wireless path quality is larger than the corrected threshold value (S65). If the value of the wireless path quality is not larger than the corrected threshold value (No at S65), the packet processor 13 waits for a predetermined time (S66), and returns the processing to S63. If the value of the wireless path quality is larger than the corrected threshold value (Yes at S65), the packet processor 13 returns the processing to S60, and performs the RTT verification processing again.

As described above, in the second modification, after the communication distance to the content receiver 2 is determined to be outside the predetermined range through the RTT verification processing, if the value of the wireless path quality to the content receiver 2 is larger than the corrected threshold value and if the communication distance to the content receiver 2 is determined to be within the predetermined range based on the communication quality, the RTT verification processing is performed again to determine if the communication distance to the content receiver 2 is within a predetermined range. Therefore, in the second modification, even if the RTT verification processing at the first time has been verified to be NG, the RTT verification processing is performed again after the communication state becomes stable to perform the transmission of the content using the first content protection method.

A second embodiment in which whether the communication distance between the content transmitter and the content receiver is within a predetermined range is determined using a global positioning system (GPS) will now be described.

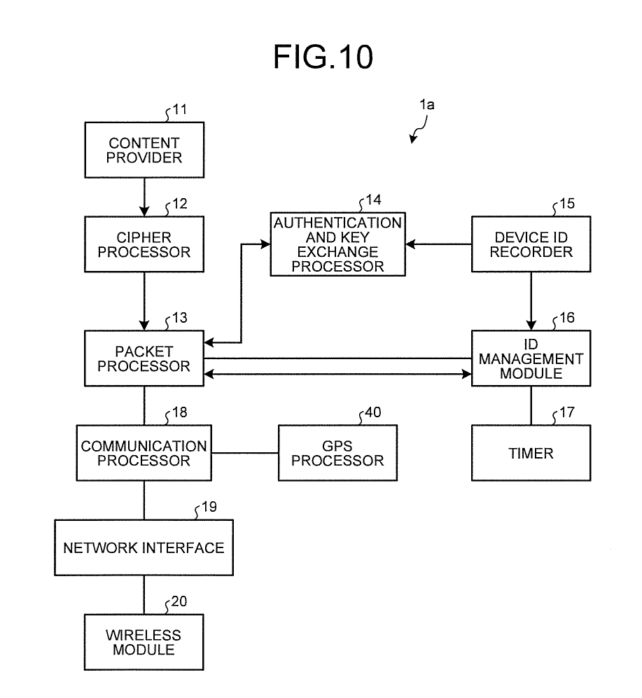

FIG. 10 is a block diagram of an example of operations of a content transmitter 1a in the second embodiment. As illustrated in FIG. 10, the content transmitter 1a comprises a GPS processing module 40 that obtains a GPS signal as position information indicating the position of the content transmitter itself to calculate the position.

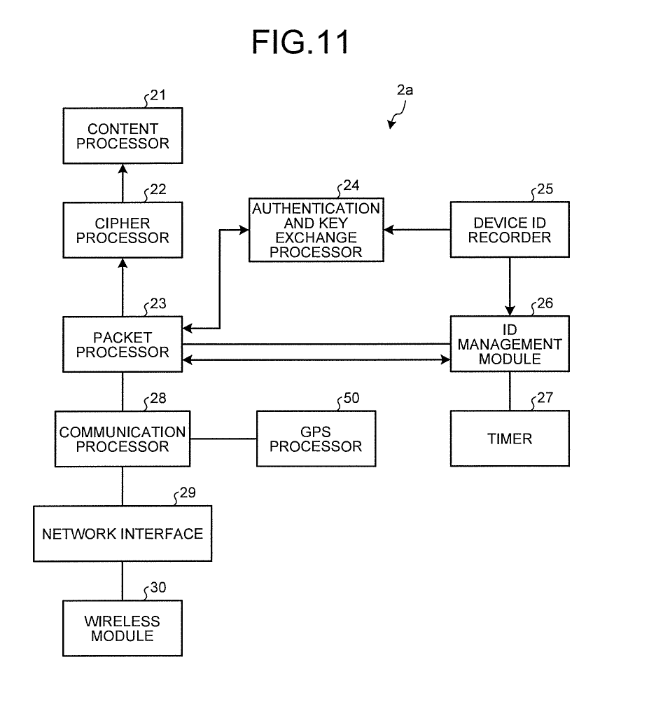

FIG. 11 is a block diagram of an example of a function structure of a content receiver 2a in the second embodiment. As illustrated in FIG. 11, in the same manner as the content transmitter 1a, the content receiver 2a comprises a GPS processing module 50 that obtains a GPS signal as position information indicating the position of the content receiver itself to calculate the position. The communication processor 28 of the content receiver 2a notifies the content transmitter 1a that is coupled to and communicated with the content receiver 2a of the position calculated by the GPS processing module 50.

The communication processor 18 of the content transmitter 1a compares the position of the content transmitter calculated by the GPS processing module 40 and the position notified by the content receiver 2a to determine whether the communication distance to the content receiver 2a is within a predetermined range. Specifically, if the content transmitter 1a is a television receiver installed at home, in the content transmitter 1a, a GPS signal indicating a position at home is obtained from the in-home GPS repeater. In addition, if the content receiver 2a is also installed at home, the same GPS signal can be obtained from the in-home GPS repeater. If the content receiver 2a is carried out of the home, the GPS signal is obtained out of the home, which is different from the GPS signal from the GPS repeater. Therefore, in the content transmitter 1a, by comparing the GPS signal indicating the position of the content transmitter 1a and the GPS signal indicating the position of the content receiver 2a, and by determining whether the same GPS signals are obtained, whether it is in a home or out of the home can be verified.

The program executed on the content transmitter 1 or the content receiver 2 in the embodiments is provided in a manner installed in a ROM or the like in advance. The program executed on the content transmitter 1 or the content receiver 2 in the embodiments may be provided in a manner recorded as an installable or executable file format in a computer-readable recording medium, such as a compact disk read-only memory (CD-ROM), a flexible disk (FD), a compact disk recordable (CD-R), and a digital versatile disk (DVD).

Furthermore, The program executed on the content transmitter 1 or the content receiver 2 in the embodiments may be provided in a manner stored in a computer connected to a network such as the Internet so as to be downloaded through the network. The program executed on the content transmitter 1 or the content receiver 2 in the embodiments may be provided or distributed over a network such as the Internet.

The program executed on the content transmitter 1 or the content receiver 2 in the embodiments has a module structure comprising the above-described function structures. In actual hardware, the CPU (processor) reads the programs from the ROM and executes the program. Once the program is executed, the above-described function structures are loaded into a main storage module, so that the function structures are formed in the main storage module.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content transmitter comprising:
a communication module configured to communicate with a content receiver;
a content protector configured to transmit a content using a first protection method on a transmission path between the content receiver and the content transmitter;
a determination module configured to determine whether a communication distance of the transmission path is within a predetermined range based on a communication with the content receiver; and
a controller, wherein,
the controller is configured to cause the content protector to start transmitting the content using the first protection method if it is determined that the communication distance is within the predetermined range,
the controller is configured to cause the determination module to intermittently determine whether the communication distance is within the predetermined range during the transmission of the content,
the controller is configured to cause the content protector to continue the transmission of the content using the first protection method if it is determined that the communication distance is within the predetermined range during the transmission of the content, and
the controller is configured to cause the content protector to stop the transmission of the content using the first protection method if it is determined that the communication distance is outside the predetermined range during the transmission of the content.

2. The content transmitter of claim 1, wherein the controller is configured to cause the determination module to determine whether the communication distance is within the predetermined range if a predetermined time has elapsed or a state of communication with the content receiver has changed during the transmission of the content.

3. The content transmitter of claim 1, wherein
the content protector is further configured to perform transmission of the content using a second protection method which requires no determination that the communication distance is within the predetermined range, and
the controller is configured to cause the content protector to start the transmission of the content using the second protection method if it is determined that the communication distance is outside the predetermined range before or during the transmission of the content.

4. The content transmitter of claim 3, wherein
the first protection method is configured to encrypt the content and transmit the content on the transmission path, and
the second protection method is configured to add management information for managing copying of the content to the content and transmit the content.

5. The content transmitter of claim 3, wherein the second protection method is configured to lower a transmission rate to be lower than a transmission rate of the first protection method, and transmits the content.

6. The content transmitter of claim 1, wherein the determination module is configured to obtain quality information representing quality of the communication with respect to the content receiver, and to determine whether the communication distance estimated from the quality information obtained is within the predetermined range.

7. The content transmitter of claim 6, wherein
the quality information is a carrier to noise ratio (CNR) or a carrier to interference and noise ratio (CINR), and
the determination module is configured to determine that the communication distance of the transmission path is within the predetermined range if the quality of the communication indicated by the CNR value or the CINR value is larger than a predetermined threshold.

8. The content transmitter of claim 7, wherein
the determination module is configured to calculate, based on the quality information obtained and a transmission rate for the transmission of the content, an error rate for the transmission of the content with reference to table information for each transmission rate in the communication module,
relationship between the quality information and the error rate for the transmission of the content is described in the table information, and
the determination module is configured to determine that the communication distance of the transmission path is within the predetermined range if the quality of the communication indicated by the CNR value or the CINR value is larger than a predetermined threshold which is based on a communication time period in the communication distance calculated in accordance with the error rate calculated.

9. The content transmitter of claim 1, wherein
the determination module is configured to measure a round trip time with respect to the content receiver, and
the determination module is configured to determine that the communication distance of the transmission path is within the predetermined range if the value of the round trip time measured is smaller than a predetermined threshold.

10. The content transmitter of claim 9, wherein the determination module is configured to measure the round trip time in a communication session different from a communication session in which the content is transmitted, if the round trip time is measured during the transmission of the content.

11. The content transmitter of claim 9, wherein the determination module is configured to determine that the communication distance of the transmission path is within the predetermined range if a communication time period, which is based on frequency of a plurality of measurement values obtained by measuring the round trip time a plurality of times, is smaller than a predetermined threshold.

12. The content transmitter of claim 1, wherein
the determination module is configured to measure the round trip time with respect to the content receiver if the communication distance estimated from quality information representing the quality of the communication with the content receiver is within a predetermined range, and
the determination module is configured to determine that the communication distance of the transmission path is within the predetermined range if the measurement value of the round trip time is smaller than the predetermined threshold.

13. The content transmitter of claim 1, wherein
the determination module is configured to measure a round trip time with respect to the content receiver, and
the determination module is configured to measure again the round trip time to determine whether the communication distance of the transmission path is within the predetermined range if, after it is determined from the round trip time that the communication distance of the transmission path is outside the predetermined range, it is determined that the communication distance estimated from quality information representing the quality of the communication with respect to the content receiver is within the predetermined range.

14. The content transmitter of claim 1, further comprising an obtaining module configured to obtain position information indicating a position of the content transmitter, wherein
the determination module is configured to determine whether the communication distance of the transmission path is within the predetermined range based on position information indicating the position of the content receiver notified by the content receiver and based on the position information obtained.

15. The content transmitter of claim 1, wherein
a plurality of transmission paths exist between the content receiver and the content transmitter, and
if it is determined that the communication distance of the transmission path is outside the predetermined range before or during the transmission of the content, the controller is configured to switch the transmission path to another transmission path which is different from the transmission path determined, and transmit the content using the first protection method.

16. A content transmission method implemented by a content transmitter comprising:
a communication module configured to communicate with a content receiver;
a content protector configured to transmit a content using a first protection method on a transmission path between the content receiver and the content transmitter; and
a determination module configured to determine whether a communication distance of the transmission path is within a predetermined range based on a communication with the content receiver,
the content transmission method comprising:
causing the content protector to start transmitting the content using the first protection method if it is determined that the communication distance is within the predetermined range,
causing the determination module to intermittently determine whether the communication distance is within the predetermined range during the transmission of the content,
causing the content protector to continue the transmission of the content using the first protection method if it is determined that the communication distance is within the predetermined range during the transmission of the content, and
causing the content protector to stop the transmission of the content using the first protection method if it is determined that the communication distance is outside the predetermined range during the transmission of the content.
